(19) United States
(12) Patent Application Publication
(10) Pub. No.: US 2015/0059803 A1
(43) Pub. Date: Mar. 5, 2015

(54) DEVICE FOR MILLING THE WELDING REGION OF SPOT WELDING ELECTRODES

(71) Applicant: Stefan Fahnenstich, Maisach (DE)

(72) Inventor: Stefan Fahnenstich, Maisach (DE)

(21) Appl. No.: 14/343,219

(22) PCT Filed: Sep. 13, 2012
(86) PCT No.: PCT/EP2012/067961

§ 371 Date: Oct. 14, 2014

(30) Foreign Application Priority Data
Sep. 13, 2011 (EP) 11181013.1

(51) Int. Cl. B23K 11/30; B23Q 11/02; B08B 7/00; B23B 5/16

(52) U.S. Cl. CPC B23K 11/3063; B23B 5/166; B23Q 11/02; B08B 7/00
USPC 134/6; 409/137

(57) ABSTRACT

Device for milling the welding region of spot welding electrodes, including at least one milling tool (21) with a cleaning unit (24) which is configured for cleaning the milling tool and has at least one movable mechanical cleaning element, such as a brush (26).

The present invention relates to a device for milling the welding region of spot welding electrodes according to the preamble of the claim, as well as a method for cleaning a device for tip dressing according to the preamble of claim 10.

Resistance spot welding, hereinafter electrode spot welding, is used for connecting steel plates in particular in the automobile industry and in body and vehicle construction. Frequently, the body plates to be spotted are welded together with the aid of robotic welding tongs. In the process, the wear on the spot welding electrodes, referred to hereinafter as electrodes for short, must be taken into account. After a certain number of welding operations, burn-off and oxide layers deposited on the electrodes during welding accumulate to the extent that electrodes alter their effective cross-section, and ultimately their electrothermic properties change as a result, which can lead to a deterioration in the quality of the spot welds. Typically, the electrodes must be milled off after some tens to hundreds of welding operations to be able to be used for further welding operations. For this purpose, devices, so-called tip dressers, are used for milling the welding region of the spot welding electrodes. The milling tools of the tip dressers mill the welding region of the electrodes so that after milling they may continue to be used.

Measures are discussed in the prior art for removing milling chips/shavings produced during milling of spot welding electrodes by suctioning and/or blowing them off during the milling process. The PCT publication WO97/44153, for example, shows a milling unit for tip dressing spot welding electrodes with a milling tool having typically four milling edges. A milling unit in this case is supplemented by suction ducts through which the chips accumulating during milling can be suctioned off. Furthermore, it is also possible to use an air injection nozzle in order to generate a turbulent air flow in the suction duct and to boost the suctioning.

The above described suctioning measures of the prior art, however, are strongly dependent on the use of vacuum pumps and air injection, each of which requires devices that are difficult to handle. In modern operations, for example, in auto body construction, the aim is further to reduce the use of compressed air, since this can fail and is therefore not considered sufficiently reliable.

In view of the problems discussed, it is therefore the object of the present invention to clean the devices and tools, in particular milling tools, used during the milling of spot welding electrodes, and to thereby reduce as much as possible or even avoid altogether the use of vacuum pumps or compressed air. This aim is achieved with a device having the features of claim 1, as well as with a method having the features of claim 10.

The invention provides a device for milling the welding region of spot welding electrodes, which comprises at least one milling tool having a cleaning unit which is configured to clean the milling tool, and comprises at least one movably configured mechanical cleaning element such as, for example, a brush. With a movably configured mechanical cleaning element it is possible to clean the generally stationary milling tool. A mechanical cleaning element is able to clean the tool by bringing the cleaning element into contact with the milling tool.

In the device as described above, the cleaning unit may comprise one or multiple axes, by means of which the mechanically configured cleaning element executes one or multiple of a linear, rotating or swiveling movement. In addition to the mobility of the mechanical cleaning element per se, the latter can also execute linear, that is, translational, rotating or swiveling movements which overlappingly or in sequence can significantly enhance the cleaning effect. Thus, by movement of the axes, the mechanical cleaning element is set into motion and, as a result of the mechanical processing, such as brushing, dirt particles, in particular, copper debris, oil droplets, adhesive debris or dust is removed from the milling tool to be cleaned.

In the device according to the invention as described above, the cleaning unit and/or the axes of the cleaning unit can be driven by one or multiple of a mechanical, pneumatic or electric component. This yields great flexibility in the choice of drive of the cleaning unit, in which consideration may be taken as to which component is used, even in the welding unit that carries out the welding operation.

In the device as described above, the cleaning unit may comprise various cleaning elements. The various mechanical cleaning elements may, for one, be special brushes, for example round brushes or flexible brushes, those for example, in which the brush, i.e. the brush head and not just the bristles, are capable of flexible movement. In addition, cloths or wipers may also be used as cleaning elements. Depending on the type of cleaning element used, the particles rubbed off, i.e. removed during the cleaning process fall through the milling tool or away from it or adhere to the cleaning element, in particular cloths and wipers.

To collect rubbed off, i.e. removed particles in particular, the device as described above may further comprise a collecting unit or collecting device. The collecting unit collects dirt particles that are rubbed off during cleaning and that typically fall through force of gravity. A collecting unit of this type may, for example, be connected to a removable cartridge for catching the particles, or the collecting unit itself can be configured to be detached in a suitable manner from the cleaning unit or the milling device. At the same time, the dirt particles rubbed off during the cleaning process can be gathered and collected locally.

In the above described device the cleaning unit may also be configured to clean carcasses, cutting edges, welding tongs, quills, electrode holders of the device and of the milling tool or also soldering elements on the welding device. Thus, using the cleaning unit with suitable brushes or cleaning elements such as cloths or wipers, it is possible to clean other parts of the device in addition to the milling tool.

The device according to the invention may also comprise a cover or a housing for the cleaning unit, the cover or housing being configured to protect the surroundings from particles removed during the cleaning process. Thus, the aspect highlighted in particular is that the removed, i.e. rubbed off particles may be shielded from the surroundings by a cover or a housing, that is, the cover and housing are to be understood as a shielding. The cover, housing or shielding should be viewed together with the collecting unit and localize the rubbed off and removed particles. Cover and housing or shielding in this case may be configured so as to be removably, hingedly or pivotally attached or configured on the housing for the cleaning unit or on the housing of the device.

The invention further provides a method for cleaning a device for tip dressing, which comprises: bringing at least one mechanical cleaning element of a cleaning unit into contact with the milling tool of the device, the at least one mechanical cleaning element for cleaning the milling tool being movably configured. Thus, the method cleans the milling tool with the aid of a mechanically configured cleaning element, such as a brush which is movably configured, the cleaning taking place before or after tip dressing with the aid of the tool. In this method it is possible to integrate the cleaning process in an automation chain and, after a certain period of milling operations, for example, after or before each milling operation or in longer intervals, to bring one or more mechanical cleaning elements of the cleaning unit into contact with the milling tool in order to appropriately clean it. In the process, if two milling tools or multiple milling tools are present next to one another, for example, one may be cleaned while another is being used to mill.

The method may also comprise moving the mechanical cleaning elements, such as the brush, in one or multiple of a linear, rotating or pivoting direction. In particular, the movement of the mechanical elements may be flexible, since the milling tool may be suitably supported in a holder in which the milling tool is able to rotate and the position of the milling tool is thereby fixed. During movement, it is possible to utilize spatial adaptability and alignment as well as orientation of the mechanical cleaning elements, and likewise clinging of the mechanical cleaning element when lightly pressed down. The method may therefore comprise a combination or sequence of several movements of the mechanical cleaning element for cleaning.

In particular, the method as described above may comprise the movement of the brush about one or more axes of the cleaning element. The movement of the brush in the form of linear, rotating or swiveling movement may also be decoupled with the aid of multiple axes, such that particularly efficient movement of the brush may be achieved. Furthermore, the cleaning element may be driven within the above method and/or within the axes of the cleaning unit by one or multiple of a mechanical, pneumatic or electric component.

The method according to the invention may also comprise covering or surrounding the cleaning unit during cleaning of the device used for tip dressing. Hence, this involves shielding at least parts of the surroundings from particles rubbed off during cleaning that potentially move through the air, and in addition this may may be combined with the collection of the particles which fall by force of gravity.

The method may further comprise the cleaning of carcasses, cutting edges, welding tongs, quills, electrode holders or soldering elements of the device and of the milling tool.

The subject matter of the invention is explained by way of example in greater detail below with reference to the following drawing.

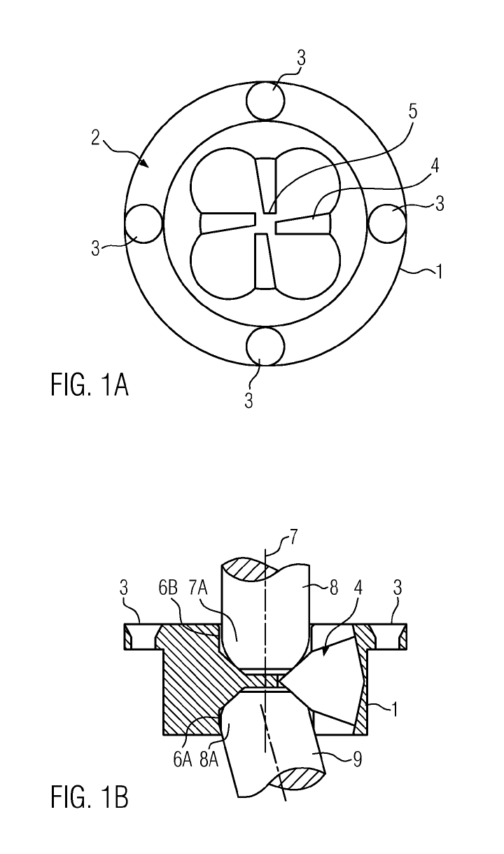

FIG. 1A: shows a milling cartridge having four milling edges with milling blades, arranged in spoke-like fashion.

FIG. 1B: shows a milling cartridge having two holder sockets for milling two electrodes

FIG. 1C: shows a tool carrier with a milling cartridge and housing parts.

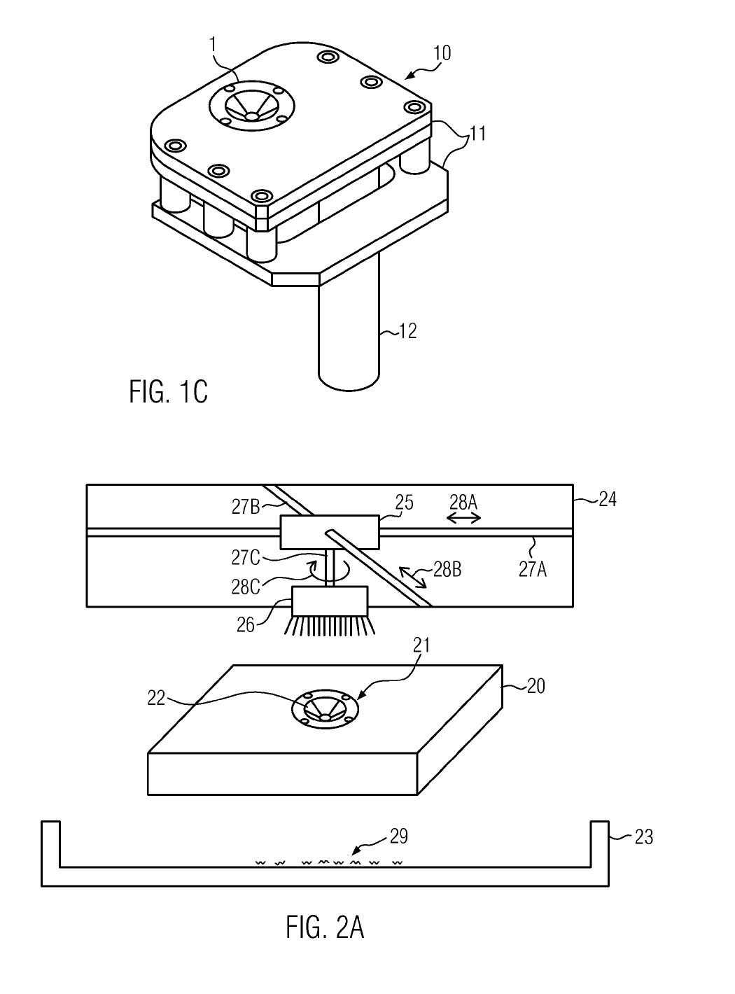

FIG. 2A: shows a tool carrier having a milling cartridge and cleaning unit for cleaning according to the present invention.

FIG. 2B: shows a movable brush of a cleaning unit according to the present invention.

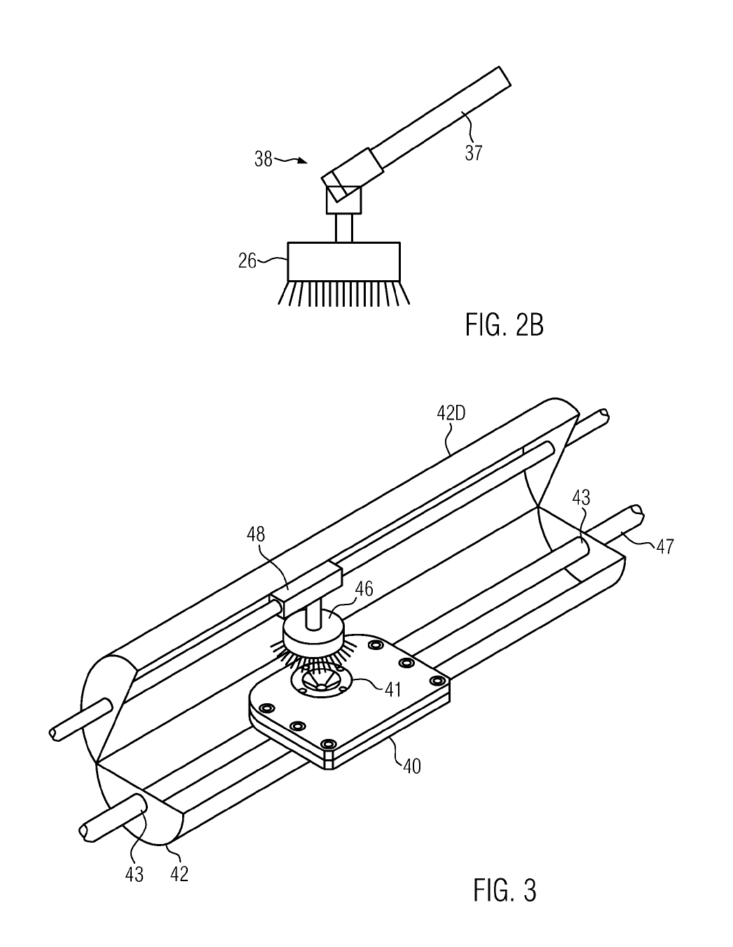

FIG. 3: shows a cleaning unit for cleaning a milling tool having a brush attached to one axis and a tool carrier with a milling tool corresponding to the present invention.

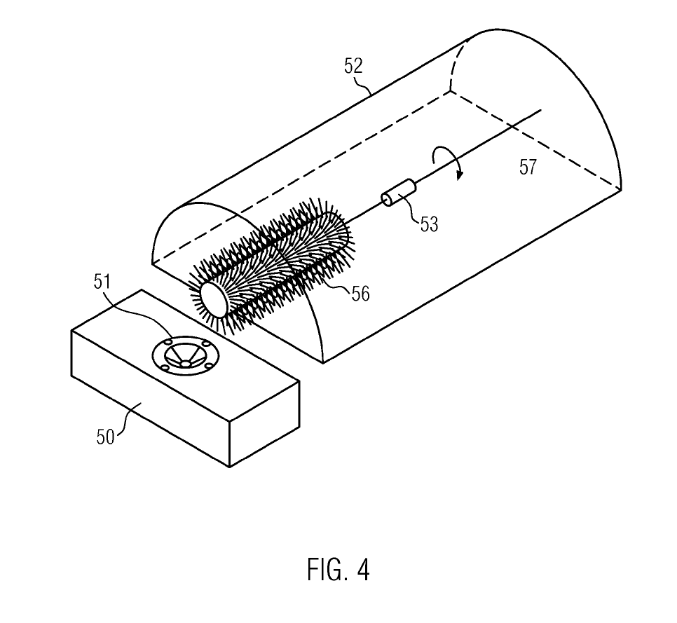

FIG. 4: shows a further embodiment of a cleaning unit having a brush and a shielding.

FIG. 1A shows a milling cartridge 1 as is known in the prior art. Milling cartridges of this type may have one or multiple milling edges with milling blades 4. In the present case, four milling edges with milling blades 4 are shown in spoke-like arrangement in the interior region 5 of the milling cartridge 1. The milling cartridge 1 has an annular body 2 with fastening holes 3, four fastening holes in the present case, with which to fasten the milling cartridge in a tool carrier, see below. In this design, the spoke-like, i.e. open attachment 5 of the milling blades may advantageously be at the milling edges 4, which can occur on both sides, that is, in the perspective in FIG. 1 above and below the annular body 2, as a result of which the milled chips are able to fall through the milling cartridge.

FIG. 1B shows a corresponding milling cartridge 1 as depicted in FIG. 1a, in this case however, by way of example, shown with just one milling blade 4, which is symmetrically configured so that the electrodes 8 and 9, which are mounted for example on robotic welding tongs and guided through the holder sockets 6a and 6b, may be milled by the milling cartridge 1, i.e. the milling tool. The milling tool, i.e. the milling cartridge 1 is suitably fixed in a further holder not shown, in which the milling cartridge 1 can properly rotate, specifically typically about the corresponding rotational axis 7 as indicated. Thus, the regions of the electrodes to be milled are the regions 7a and 8a.

FIG. 1C shows an example of a tool carrier 10 with housing parts 11 and a gear component 12 in which a milling cartridge 1 is engaged as a milling tool as known in the prior art.

FIG. 2A shows a device according to the invention having a cleaning unit 24 configured for cleaning the milling tool 21 which is similar to the milling tool described above, and has milling blades 22, and is supported in a tool carrier 20. The cleaning unit 24 comprises in particular at least one flexible brush 26, whereby in addition or instead, other cleaning elements such as wipers or cloths not shown here may be used. The brush 26 is mounted on a shaft 27c and also movable over additional axes or shafts 27a and 27b, which are able to allow movement of the brush along the arrows 28a and 28b, for example, whereby the movements may occur by means of a suitable worm thread, not shown here or via an electromotor control, not shown here. Correspondingly, the brush may also be suitably adjustable for height along the shaft 27c so that it may be lowered onto the tool. The rotational movement of the brush is depicted by the direction of movement 28c. In addition, a swivel mechanism may also be provided in the drive unit 25 so that the brush 26 can be swiveled on a swivel joint constructed in the drive unit or near the drive unit 25. The brush 26, as well as other cleaning elements not shown here may be appropriately flexibly adapted or are adaptable to cleaning the milling tool 21 which is supported by the tool carrier 20. Also shown in FIG. 2 is a collecting unit 23 of the device according to the invention, the collecting unit 23 typically being mounted beneath the cleaning unit 24 or beneath the area of the milling tool 21 to be cleaned and its holder 20 and other parts of the device according to the invention, by means of which particles 29 that fall during cleaning may be collected. The collecting unit 23 may, for example, be broader/wider in design than the milling tool 21 together with its holder 20. For example, the collecting unit may have a width double or three times that of the holder 20, other widths also being possible. The collecting unit may be even wider in design than the cleaning unit. The collecting unit 23 shown in FIG. 2 is box-shaped in design having side walls which are significantly lower in height, for example, only ⅕to 1/10 the width of the collecting unit. It is equally possible, however, for the collecting unit to be trough-shaped, rather than box-shaped in design, not shown here. That means the transition from the bottom of the collecting unit to the side walls is rounded.

In terms of the device with the cleaning unit according to the invention, as described with respect to FIG. 2a, the mechanical cleaning element, the brush 26, for example, as well as optionally other cleaning elements not shown, is able to move. For this purpose, as shown in FIG. 2B, in particular the brush 26—as depicted herein may have a universal joint 38 on a corresponding axis or shaft 37, as it may be used in conjunction with the cleaning unit 24 of the device, as described in FIGS. 2A and 2B.

With respect to a further shielding of the cleaning process, FIG. 3 shows a cover, housing or shielding 42 of the present invention which has a foldable cover 42d and a cleaning element 46, shown here as a brush, which may be identical to the brush 26 described in FIG. 2A, only one exemplary axis 43 being shown, but it is understood that this embodiment may also include multiple axes. The tool carrier 40 includes, by way of example, a milling cartridge 41, multiple milling cartridges being of course possible. By this means, the milling tool 41 to be cleaned is suitably supported, the brush 46 is inserted and is able to appropriately move at least along the axis 47 and suitably rotate or pivot via a further axis not shown here, such that the milling tool is suitable cleaned. Here, the cover or shielding may be designed as a housing which may be largely covered with the cover 42 and which is able to receive the dirt particles that fall during cleaning.

FIG. 4 shows another embodiment of a cleaning unit as described above. In this unit, a milling tool 51 may be cleaned with an elongated, movable cleaning element in the form of an elongated brush 56. The milling tool 51 and its holder 50 resemble the milling tools and supports as described in FIGS. 2A, 2B and 3. The elongated brush is attached to a shaft or axis 57. The shaft 57 may rotated as indicated in FIG. 4. The brush 56 may be attached at a joint 53, in particular a bend may also be present here. The brush 56 has an elongated head with bristles as shown in FIG. 4. Over the brush 56, which may rotate for the purpose of cleaning the milling tool, a shielding 52 may be placed with which to control the scattering of rubbed off particles, not shown here.

It is understood that the features cited in the exemplary embodiments described above are not limited to these specific combinations and may be possible in any other arbitrary combinations as well.

1. A device for milling the welding region of spot welding electrodes, comprising at least one milling tool, and a cleaning unit configured for cleaning the milling tool, comprising at least one movable mechanical cleaning element.

2. The device according to claim 1, wherein the cleaning unit comprises one or more axes by means of which the mechanical cleaning element executes one or multiple of a linear, rotating or pivoting movement.

3. The device according to claim 1, wherein the cleaning unit and/or the axes of the cleaning unit are driven by at least one of a mechanical, pneumatic or electric component.

4. The device according to claim 1, wherein the cleaning unit comprises various mechanical cleaning elements.

5. The device according to claim 1, wherein the mechanical cleaning elements of the cleaning unit are round brushes or flexible brushes and wherein the cleaning unit also comprises cloths or wipers.

6. The device according to claim 1, wherein the cleaning unit is supported by a detachable fastening device, which is fastened to a component of the tip dresser.

7. The device according to claim 1, having a collecting unit for the particles that are rubbed off during cleaning.

8. The device according to claim 1, wherein the cleaning unit is further configured to clean carcasses, cutting edges, welding tongs, quills, as well as electrode holders of the device and of the milling tool.

9. The device according to claim 1, further having a cover or a housing for the cleaning unit, wherein the cover of the housing is configured to protect the surroundings from particles removed during the cleaning process.

10. A method for cleaning a device for tip dressing comprising:
bringing at least one mechanical cleaning element of a cleaning unit into contact with the milling tool of the device, wherein the at least one mechanical cleaning tool is movable for cleaning the milling tool.

11. The method according to claim 10, further comprising: moving the mechanical cleaning element in at least one of a linear, rotating or swiveling movement.

12. The method according to claim 11, wherein the mechanical cleaning element is moved about one or more axes of the cleaning element.

13. The method according to claim 10, further comprising: driving the cleaning unit and/or the axes of the cleaning unit by means of at least one of a mechanical, pneumatic or electric component.

14. The method according to claim 10, further comprising: covering or surrounding the cleaning unit during cleaning of the device for tip dressing.

15. The method according to claim 10, wherein cleaning further extends to carcasses, cutting edges, welding tongs, quills as well as electrode holders of the device and of the milling tool.

16. The device according to claim 1, wherein the cleaning element is a brush.

17. The device according to claim 6, wherein the component is a gearing or a housing portion of the tip dresser.
